(19) United States
(12) Patent Application Publication
(10) Pub. No.: US 2010/0232922 A1
(43) Pub. Date: Sep. 16, 2010

(54) Reel handling device

(76) Inventor: Gerald Mark Zenon, Omaha, NE (US)

Correspondence Address: GERALD MARK ZENON, 3103 NICHOLAS, OMAHA, NE, 68131, US

(21) Appl. No.: 12/381,403

(22) Filed: Mar. 11, 2009

(51) Int. Cl. B66C 1/10

(52) U.S. Cl. 414/754

(57) ABSTRACT

The inspiration to the “Device” conception was to ease strenuous conditions associated with physical requirements for moving extremely heavy reeled, spooled, or rolled units.

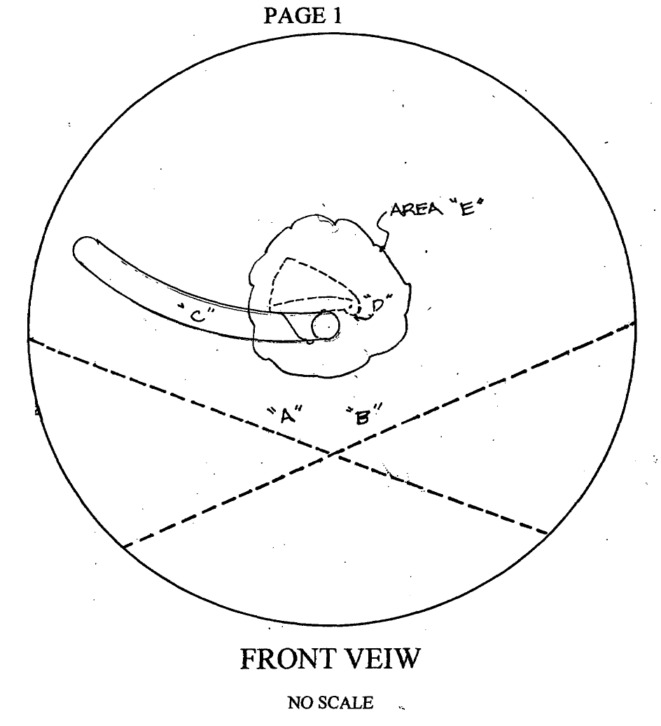

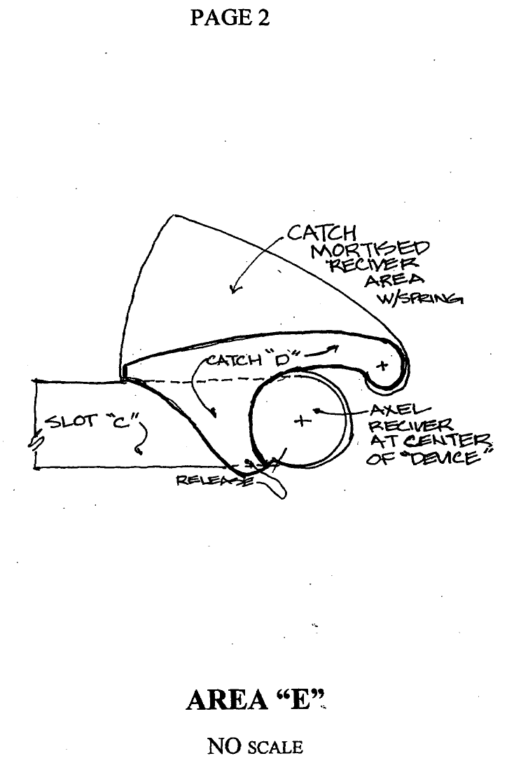

The “Device” is a new instrument for use in handling large spools/reels. “Handling” is implied but not limited to interim transportation, and methods required to complete the function for final release of material from reels/spools. The simple machine concepts are integrated into the “Device” hereunder the Description in this document. Thereby claiming that unique combinations of proven concepts and principals to the Laws of nature, specifically Conservation of Energy; secure this culmination as intellectual property and claimed hereby this Non-Provisional Application.

The first generation of devices will be made of wood. Wood is available in dimensional and sheet good form. Wood is easily cut and shaped and; possess the physical qualities sufficient to cover the stress specifications for the Device.

Second and Third generations are to be engineered molds and recycled and or lightweight plastics.

### BACKGROUND OF THE INVENTION

In situations where powered equipment is not available, there exist problematic situations through out the process; to complete the ultimate function of releasing the materials applied to (spools/rolls/reels). The Device is designed to resolve situations listed below.
1) Transporting the reel.
First the spools/reels must arrive to a designated area. Many times the spools are damaged and will be handled in some intuitive ways.
2) Manipulating the reel into position.
This requires physical manhandling of the spools. This is done by using the axel as a lever to turn and or aim the reel into position. Another method is, for one man applying rotation by bending over and grabbing the spool center on each side and literally lift, twist and pull the spool to pivot it into the desired position. This is a common technique.
3) Elevating spooled material.
Spools provided with axel holes and axels; are raised by setting the axel on jack stands. Most commonly the worker will lift the spool and axel on to the stand.
4) A traditional wire pull set up for (i.e.) electricians; is 4 rolls of wire approx 500# to 750#ea. on one or more axels; lifted and set at each end on jacks. Picture this set up on various terrain, now an additional problem arrives where the assembly is subject to tip, posing a crush hazard and reassembly.

The “Device” design is drawn toward; replacing Reel jacks that are cumbersome to move, end up scattered and misplaced around the job site mostly because they are difficult to store. Jacks are known to tip over causing a complete re-setup.

Maneuvering materials in tight quarters are applicable.

### SUMMARY

Remedial goals of the “Device” are to:
1) Provide a tool to greatly assist and reduce manhandling reels weighing several hundred pounds.

And;
2) Reduce back strain; due to bending and lifting, one of the most prevalent job related injuries.

And;
3) Provide a vehicle to transport reels where power lift equipment is not available or assessable

And;
4) Compensate for reels that are damaged.

And;
5) More easily maneuver reels into position, or in tight spaces such as catwalks

And;
6) Reduce, pinch points and tip-over.

And;
7) Easy moving, securing and storage of the “Device”.

### DISCRIPTION OF DRAWING

The description of the “Device” in the Drawing is, a shallow cylinder; of wheel proportion; approx. 4′ radius 3″ high. When viewing the front, the deg. orientation is (right center=(0, 360 deg.).

Components of the Device are shown items A, B, slot C, and catch D within area E

It has two shafts; “A” along a cord from 180 deg. to 315 deg. & “B” along a cord from 225 deg. to 0, 360 deg. These shafts are one inch sq or in diameter at elevations +1¼″and +2¼″ to centerlines of these shafts from a back bottom elevation of 0. “A” & “B” are for insertion of the pipe to be used as leavers and braces.

There is a thru-slot “C” of a 4′ arch along the 160 deg. radii, 2″ wide, extending from 2″ from the perimeter to a 2″ axis hole at the center where cache mechanism “D” is placed to hold an axel at the center.

### Operating Instructions

Tools needed for one reel setup
1) Provide a ridged 2″ axel customize length,
2) Provide 4) ea. 6′ long by ¾″ diameter leaver handles
3) Provide 2) ea. Devices one on each side of the reel

Steps:
1) Insert a 2″ axel thru the reel.
2) Organize the “Devices” symmetrically on each side of the reel. Insert axel thru the most peripheral position of slot “C” of both devices.
3) Position the “Devices” very near the reel.
4) Insert a leaver bar (of sufficient length approx. 6′) into shaft “A”.
5) Insert a leaver bar (of sufficient length approx. 6′) into shaft “B”.
6) Pull the top leaver as to initiate input force; additional force can be applied to the lower leaver with body weight; transferring output force to the axel in slot “C”.
8) Continue to apply input force until the axel falls into the center of the “Device”.
9) As the lower leaver reaches the ground; slide the top leaver thru to the ground; to achieve the cradle position.
10) Catch “D” will hold the shaft in the center of the “Device”.
11) Repeat steps #4 thru #10 on the opposite side
12) Now that the set up is in (cradle) position the (mobile) position is available, by removing the leaver handles and rolling the unit assembly to a desired position/location.

### DISCRIPTION OF THE INVENTION

The referenced amenities to the “Device” “A”,“B”,“C”, and “D” are shown on the drawing. Axels and leavers are supplied by owner/operator.

In that laws of nature are not patentable, the “Device” applies the Law of Conservation of Energy; as most machines need motive forces to operate or run.

The “Device” may be viewed as a “better wheel”. With addition to axis hole and the cylinder shape of the wheel, other amenities have been added to the “Device” to achieve functions pertaining to the “Abstract”.

The slot “C” is in effect a cam to the axel, shafts “A”&“B” are in effect receivers for leavers/stabilizers, and catch “D” is a device to secure the axel.

For the following description; the (reel with an axel assembled) are the “Unit”. This is discussed as the “Device” moving the “Unit” as follows:
1) Appling man powered force to the leavers will in effect engage the “Device” as a First Class Leaver.
2) Applying lifting force to the unit with axel situated within the cam slot “C” Shall;
3) Initiating or inducing potential energy to the unit moving it along the cam;
   NOTE: that the fulcrum point simultaneously moves along the “Device” tangent to the ground, decreasing effort force required to peak potential energy.
4) At that peak potential, the energy is translated to kinetic energy forcing the unit to rest at the axis of the “Device”.
5) The catch “D” secures the axel at the “Device” axis. At this step the “Device and “Unit’ work as an entity.
6) By pushing leavers “A” & “B” thru to the ground; the “device” is in what is called the Cradle position ready to dispense rolled material.
7) By removing “A” & “B” the entity may be roll and maneuvered to a desired location.

1. It is the intent that the “Device's operate as several simple machines applications thus; classifying the Device as a Complex Machine. The implementation of the dynamics of the Conservation of Energy by the Device shall be inherit ant to the claimed performance of the Device.
The “Device” operated per instructions, must incorporate traditional accessories available onjobsites; (i.e.) rigid steel pipe; for use as stops, leavers, and axels; necessary to operate the “Device”.
The “Device” shall be useful in overcoming historic traditional inequities described in the Background information and provide remedial antidotes as Summarized for handling reels.
The unique positioning of slots, shafts, and holes implemented into the “Device” design; therewith input forces applied as directed for operation; shall initiate the mechanical advantage functions.
The “Device” shall minimize human muscle related injuries due to lifting, bending, pushing and some crush hazards related to handling wire pull set-ups and interim transportation of spooled reels in excess of weights required to be lifted by personnel.
This claim is related but not limited to the types of reeled, rolled, and/or spooled materials (i.e.) wire, cable, or rope or sheet-metal goods.
The “Device” also addresses problems of broken reels and maneuvering reels in tight spaces such as cat-walks, lay-down areas, warehouses where rolled reels are bought in bulk for partial roll transfers and warehouses areas where only manual labor is available.
Typical low end example; a roll of wire 1000′ long of 4/0 XHHW weight's 705#'s and, are pulled in sets of 3 or 4 at a time. Typical higher end example 5000′ of 350 mcm weight's 6500190 's.
